(19) United States
(12) Patent Application Publication
(10) Pub. No.: US 2023/0236864 A1
(43) Pub. Date: Jul. 27, 2023

(54) LAZY RESTORE OF VIRTUAL MACHINES

(71) Applicant: VMWARE, INC., Palo Alto, CA (US)

(72) Inventors: HALESH SADASHIV, Bangalore (IN); PREETI AGARWAL, San Jose, CA (US); ASHISH KAILA, Cupertino, CA (US); ABHISHEK KUMAR RAI, Bangalore (IN)

(21) Appl. No.: 17/748,058

(22) Filed: May 19, 2022

(30) Foreign Application Priority Data
Jan. 21, 2022 (IN) 202241003636

(51) Int. Cl. G06F 9/455; G06F 8/65

(52) U.S. Cl. CPC G06F 9/45558; G06F 8/65; G06F 2009/45575; G06F 2009/45583

(57) ABSTRACT

A method of restarting execution of a virtual machine (VM) on a host, after an upgrade of a virtualization software for the VM, wherein prior to the upgrade, page mapping data for mapping memory pages of the VM to first page frames located in a first region of a physical memory of the host was copied into second page frames located in a second region of the physical memory of the host includes the steps of: restarting execution of the VM on the host after the upgrade while the page mapping data for mapping the memory pages of the VM to the first page frames, are stored in the second page frames; and during said execution of the VM after the upgrade, copying a portion of the page mapping data stored in the second page frames into a third page frame located in the first region of the physical memory.

### RELATED APPLICATIONS

Benefit is claimed under 35 U.S.C. 119(a)-(d) to Foreign Application Serial No. 202241003636 filed in India entitled “LAZY RESTORE OF VIRTUAL MACHINES”, on Jan. 21, 2022, by VMware, Inc., which is herein incorporated in its entirety by reference for all purposes.

### BACKGROUND

Conventional hypervisors require a reboot after an upgrade. Recently, hypervisors implemented as part of VMware's vSphere® virtualization product, available from VMware Inc. of Palo Alto, Calif., permit upgrades without a reboot. As a result, the time required for hypervisor upgrades has been reduced drastically, especially for vSphere® configurations with multiple hosts that are managed as a cluster and that are upgraded together.

As part of this “reboot-less” upgrade, virtual machines (VMs) running on the hypervisor to be upgraded are suspended to memory. Once the hypervisor is upgraded, a “quick boot” is performed on the VMs, and the VMs are restored back from memory and resumed. However, although the VMs can be restored more quickly in this way than VMs running on conventional hypervisors could, the VMs still experience downtime across suspend and resume.

### SUMMARY

One or more embodiments provide techniques for restoring VMs after a hypervisor upgrade, with reduced downtime. These techniques reduce the time to resume the VMs after the hypervisor upgrade by “lazily” restoring the VMs. As used herein, lazily restoring the VMs means restarting the execution of the VMs before all their page mapping data has been restored and allowing the VMs to execute while their page mapping data is still in the process of being restored.

One or more embodiments provide a method of restarting execution of a virtual machine (VM) on a host, after an upgrade of a virtualization software for the VM, wherein prior to the upgrade, the execution of the VM on the host was suspended and page mapping data for mapping memory pages of the VM to first page frames located in a first region of a physical memory of the host was copied into second page frames located in a second region of the physical memory of the host. The method includes the steps of: restarting execution of the VM on the host after the upgrade while the page mapping data for mapping the memory pages of the VM to the first page frames located in the first region of the physical memory, are stored in the second page frames located in the second region of the physical memory; and during said execution of the VM after the upgrade, copying a portion of the page mapping data stored in the second page frames into a third page frame located in the first region of the physical memory.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computer system in which embodiments may be implemented.

FIG. 2 is a conceptual diagram illustrating an example of copying page frames into a memory transfer filesystem region of memory and, after upgrading of virtualization software, copying page frames out of the memory transfer filesystem region.

FIG. 3 is a flow diagram of steps carried out by a kernel and VMM of the upgraded virtualization software to carry out a method of restoring page mapping data of a VM, according to an embodiment.

FIG. 4 is a flow diagram of steps carried out by the kernel of the upgraded virtualization software to carry out a method of handling page faults, which includes restoring page mapping data of a VM, according to an embodiment.

FIG. 5 is a flow diagram of steps carried out by the kernel of the upgraded virtualization software to carry out a method of restoring page mapping data of a VM in the background, according to an embodiment.

### DETAILED DESCRIPTION

Techniques for restarting a VM after a virtualization software is upgraded are described. Before the upgrade, execution of the VM is suspended, and page mapping data for the VM is copied into a memory transfer filesystem (memxferFS) region of memory. After the upgrade, a VM monitor (VMM) of the upgraded virtualization software does not have access to the page mapping data. However, to avoid a large delay in the execution of the VM, the VM is restarted before the VMM acquires the page mapping data and before the VMM populates nested page tables. After the VM is restarted, two threads of a kernel of the upgraded virtualization software work in parallel to copy the page mapping data out of the memxferFS region and to provide the page mapping data to the VMM.

One thread, referred to herein as a “demand-faulting thread,” copies and provides page mapping data in response to page faults. Such page faults occur when the VM requests access to memory pages for which nested page tables of the VMM do not include mappings. The other thread, referred to herein as a “pre-faulting thread,” is a background thread that copies and provides page mapping data while the VM is executing. As the two threads provide the page mapping data to the VMM, the VMM populates nested page tables for each of the memory pages of the VM. The embodiments allow the virtualization software to be upgraded without introducing a large delay for the restoration of the VM. These and further aspects of the invention are discussed below with respect to the drawings.

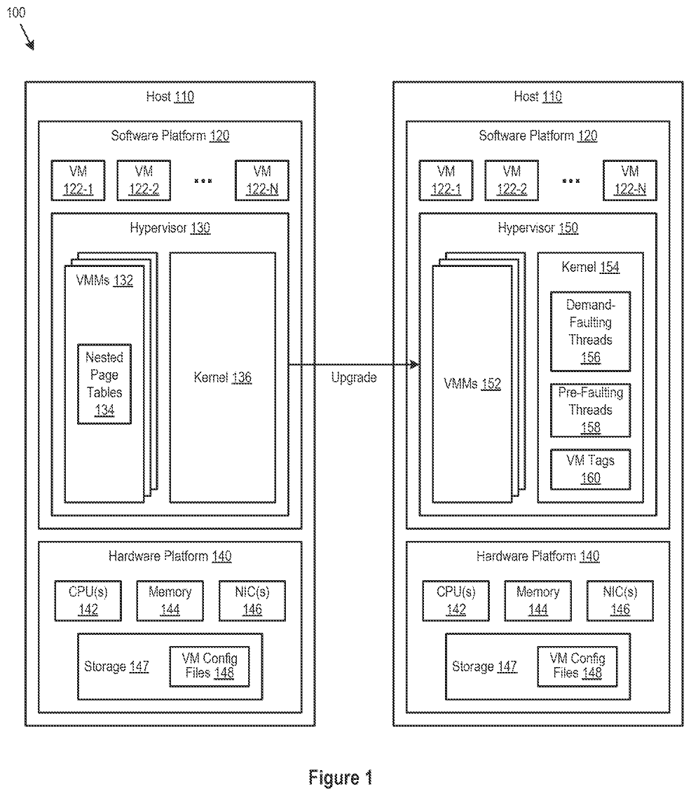

FIG. 1 is a block diagram of a virtualized computer system 100 in which embodiments may be implemented. Virtualized computer system 100 includes a host 110. FIG. 1 illustrates host 110 before (left) and after (right) an upgrade to virtualization software therein.

Host 110 is constructed on a server grade hardware platform 140 such as an x86 architecture platform. Hardware platform 140 includes conventional components of a computing device, such as one or more central processing units (CPUs) 142, memory 144 such as random-access memory (RAM), one or more network interface cards (NICs) 146, and local storage 147 such as one or more hard disk drives (HDDs) or solid-state drives (SSDs). CPU(s) 142 are configured to execute instructions such as executable instructions that perform one or more operations described herein, which may be stored in memory 144. NIC(s) 146 enable host 110 and to communicate with other devices over a physical network (not shown). Storage 147 may optionally be aggregated and provisioned as a virtual storage area network (vSAN).

Memory 144 is physically divided into page frames, each page frame being an individually addressable, fixed-length block of physical memory. Kernels 136 and 154, discussed further below, access memory 144 at the granularity of page frames. Page frames are identified by addresses referred to as “page frame numbers.”

Furthermore, CPU(s) 142 support “paging” of memory 144. Paging provides a virtual address space that is divided into memory pages, each memory page being an individually addressable unit of memory. VMMs 132 and 152, discussed further below, utilize such virtual address spaces to access memory 144 at the granularity of memory pages. Memory pages are identified by addresses referred to as “page numbers.” Furthermore, CPU(s) 142 can support multiple memory page sizes including 4 KB, 2 MB, and 1 GB.

Hardware platform 140 supports a software platform 120. Before the upgrade (left), software platform 120 includes a hypervisor 130, which is a virtualization software layer that abstracts hardware resources of hardware platform 140 for concurrently running VMs 122. One example of hypervisor 130 that may be used is a VMware ESX® hypervisor by VMware, Inc. Hypervisor 130 includes VMMs 132 and kernel 136.

VMMs 132 implement the virtual system support needed to coordinate operations between VMs 122 and hypervisor 130. Each VMM 132 manages a virtual hardware platform for a corresponding VM 122. Such a virtual hardware platform includes emulated hardware such as virtual CPUs (vCPUs) and guest physical memory. To manage guest physical memory, VMMs 132 maintain nested page tables 134.

Nested page tables 134 provide translations from guest physical page numbers (PPNs) to host physical page numbers, i.e., machine page numbers (MPNs). For example, nested page tables 134 may be arranged in hierarchies that include various levels. PPNs are addresses that appear to be physical memory addresses from the perspective of VMs 122 but that are actually virtual addresses from the perspective of hypervisor 130. MPNs are physical memory addresses of memory 144 from the perspective of hypervisor 130. When one of VMs 122 requests to read from or write to a PPN, corresponding VMM 132 walks nested page tables 134 to translate the PPN to an MPN to locate a memory page at which VMM 132 performs the read or write.

Kernel 136 provides operating system (OS) functionalities such as file system, process creation and control, and process threads. Kernel 136 also provides CPU and memory scheduling across VMs 122 and VMMs 132 and handles page faults resulting from VMs 122 requesting access to memory pages for which nested page tables 134 do not include mappings. As previously stated, kernel 136 accesses memory 144 at the granularity of page frames, mapping memory pages to page frames by, e.g., mapping PPNs to page frame numbers.

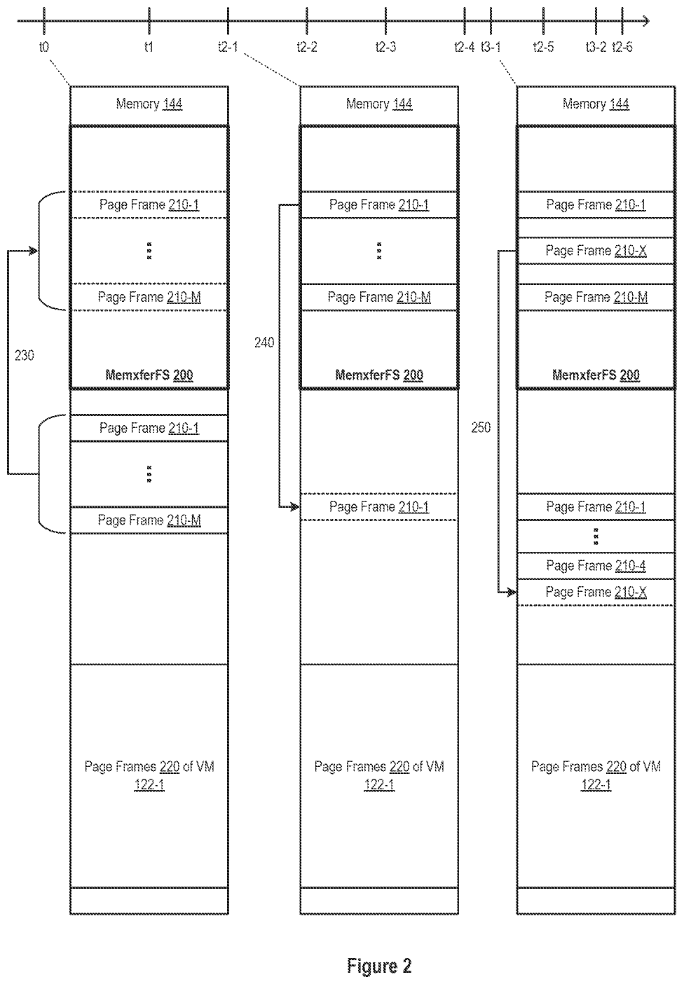

To upgrade hypervisor 130, execution of VMs 122 is suspended, and page mapping data for VMs 122 is copied into a memxferFS region (shown in FIG. 2) of memory 144. The memxferFS region is a region of memory 144 having a fixed virtual address space that is created during booting of host 110. Such page mapping data includes the PPNs and MPNs of nested page tables 134. After the upgrade (right), software platform 120 includes a hypervisor 150, which is an upgraded virtualization software layer that abstracts hardware resources of hardware platform 140 for VMs 122. Hypervisor 150 includes VMMs 152 and kernel 154.

Upon upgrade, VMMs 152 do not have access to the page mapping data copied into the memxferFS region. However, VMs 122 are restarted before VMMs 152 acquire the page mapping data and before VMMs 152 populate nested page tables. Similarly to VMMs 132, VMMs 152 implement the virtual system support needed to coordinate operations between VMs 122 and hypervisor 150. Each VMM 152 manages a virtual hardware platform for a corresponding VM 122 including emulated hardware such as vCPUs and guest physical memory.

Like kernel 136, kernel 154 provides OS functionalities such as file system, process creation and control, and process threads. Kernel 154 also provides CPU and memory scheduling across VMs 122 and VMMs 152 and handles page faults resulting from VMs 122 requesting access to memory pages for which nested page tables (not shown) of VMMs 152 do not contain mappings. As previously stated, kernel 154 accesses memory 144 at the granularity of page frames, mapping memory pages to page frames by, e.g., mapping PPNs to page frame numbers. Kernel 154 includes, for each of VMs 122, a demand-faulting thread 156, pre-faulting thread 158, and VM tag 160.

For each of VMs 122, corresponding demand-faulting and pre-faulting threads 156 and 158 work in parallel to copy page mapping data out of the memxferFS region of memory 144 and to provide the page mapping data to corresponding VMM 152. Demand-faulting threads 156 copy and provide page mapping data in response to page faults that occur when VMs 122 request access to memory pages for which nested page tables of VMMs 152 do not include mappings. Pre-faulting threads 158 are background threads that copy and provide page mapping data while VMs 122 are executing. As demand-faulting and pre-faulting threads 156 and 158 provide page mapping data to VMMs 152, VMMs 152 populate nested page tables for each of the memory pages of VMs 122.

VM tags 160 are bits indicating which of VMs 122 are in the process of being lazily restored. Upon the upgrading of hypervisor 130 to hypervisor 150 and the restarting of VMs 122, kernel 154 tags each of VMs 122 as being in the process of being lazily restored, e.g., by setting each of VM tags 160. When lazy restoration is complete for one of VMs 122, kernel 154 untags VM 122, e.g., by clearing corresponding VM tag 160.

Demand-faulting threads 156 use VM tags 160 to determine how to handle page faults. If a page fault occurs for one of VMs 122 for which lazy restoration is complete, corresponding demand-faulting thread 156 swaps the requested memory page from storage 147 into memory 144 and provides an MPN for the memory page to corresponding VMM 152. Otherwise, if a page fault occurs for one of VMs 122 for which lazy restoration is still in progress, corresponding demand-faulting thread 156 merely copies and provides page mapping data to corresponding VMM 152, as previously mentioned.

Storage 147 includes VM configuration files 148 for VMs 122. Each of VM configuration files 148 includes configurations for corresponding VM 122. To launch VMs 122, kernel 136 (before upgrade) or kernel 156 (after upgrade) reads the VM configurations from respective VM configuration files 148 and launches threads referred to as “VMX threads.” Hypervisor 130 (before upgrade) or hypervisor 150 (after upgrade) then creates VMMs 132 or 152 for VMs 122 accordingly.

FIG. 2 is a conceptual diagram illustrating an example of copying page frames into a memxferFS region 200 of memory 144 and, after upgrading of hypervisor 130, copying page frames out of memxferFS 200. At time 0, hypervisor 130 is targeted for upgrading. In the region of memory 144 outside of memxferFS 200, two sets of page frames corresponding to VM 122-1 are stored. They are page frames 210 and page frames 220. Page frames 210 store metadata of VM 122-1, including the page mapping data thereof. Page frames 220 store the remaining memory pages of VM 122-1, including data thereof. The region of memory 144 outside memxferFS 200 is referred to herein as a “VM memory region.”

In response to hypervisor 130 being targeted for upgrading, kernel 136 performs an operation 230 of copying the contents of page frames 210 into page frames of memxferFS 200. Accordingly, after operation 230, the page mapping data of VM 122-1 is stored in memxferFS 200. After upgrading, hypervisor 150 can access memxferFS 200 to retrieve the page mapping data of VM 122-1 via. corresponding demand-faulting and pre-faulting threads 156 and 158. Additionally, although not illustrated in FIG. 2, kernel 136 copies the contents of page frames storing the page mapping data of other VMs 122 into page frames of memxferFS 200.

At time 1, which is after hypervisor 130 has been upgraded to hypervisor 150, kernel 156 reads VM configurations from VM configuration files 148 and launches VMX threads. Hypervisor 150 then creates VMMs 152 for VMs 122 accordingly. At this time, nested page tables for VMs 122 managed by VMMs 152 do not contain any page mappings to physical memory. Furthermore, at time 1, kernel 154 starts pre-faulting threads 158. For example, in the background, for page frames that have not yet been copied outside of memxferFS 200, pre-faulting thread 158 corresponding to VM 1224 may sequentially copy the contents thereof into page frames outside of memxferFS 200, one page frame at a time.

At time 2-1, pre-faulting thread 158 performs an operation 240 of copying the contents of page frame 210-1 into a page frame outside of memxferFS 200, i.e., into a page frame in the VM memory region. Furthermore, although not illustrated in FIG. 2, pre-faulting thread 158 also transmits the page mapping data associated with page frame 210-1 to VMM 152. VMM 152 then populates nested page tables. including storing at least one translation from at least one PPN stored in page frame 210-1 to at least one MPN stored in page frame 210-1. At future times, including times 2-2, 2-3, 2-4, and 2-5, pre-faulting thread 158 copies the contents of additional page frames in memxferFS 200 into page frames outside of memxferFS 200 (not shown).

At time 3-1, VM 122-1 requests access to a memory page associated with a page frame 210-X, page frame 210-X being a page frame located somewhere after a page frame 210-4, within page frames 210. Specifically, VM 122-1 requests a read from or a write to a specified PPN for which nested page tables of corresponding VMM 152 do not include a mapping. As such, VMM 152 cannot translate the requested PPN an MPN to locate the requested memory page, resulting in a page fault. VMM 152 then transmits the requested PPN to kernel 154, and demand-faulting thread 156 checks corresponding VM tag 160 to determine that lazy restoration is still in progress for VM 122-1, e.g., because VM tag 160 is set.

Because lazy restoration is still in progress, demand-faulting thread 156 locates page frame 210-X, e.g., by mapping the requested PPN to the page frame number of page frame 210-X. After locating page frame 210-X, demand-faulting thread 156 performs an operation 250 of copying the contents of page frame 210-X into a page frame outside of memxferFS 200, i.e., into a page frame in the VM memory region. Furthermore, demand-faulting thread 156 also transmits the page mapping data for the requested PPN to VMM 152. VMM 152 then populates nested page tables, including storing a translation from the requested PPN to an MPN of memory 144 at which the requested memory page is stored. At future times, including a time 3-2, VM 122-1 requests access to memory pages for which page tables of VMM 152 do not include mappings, and demand-faulting thread 156 handles the page faults similarly to the handling illustrated at time 3-1.

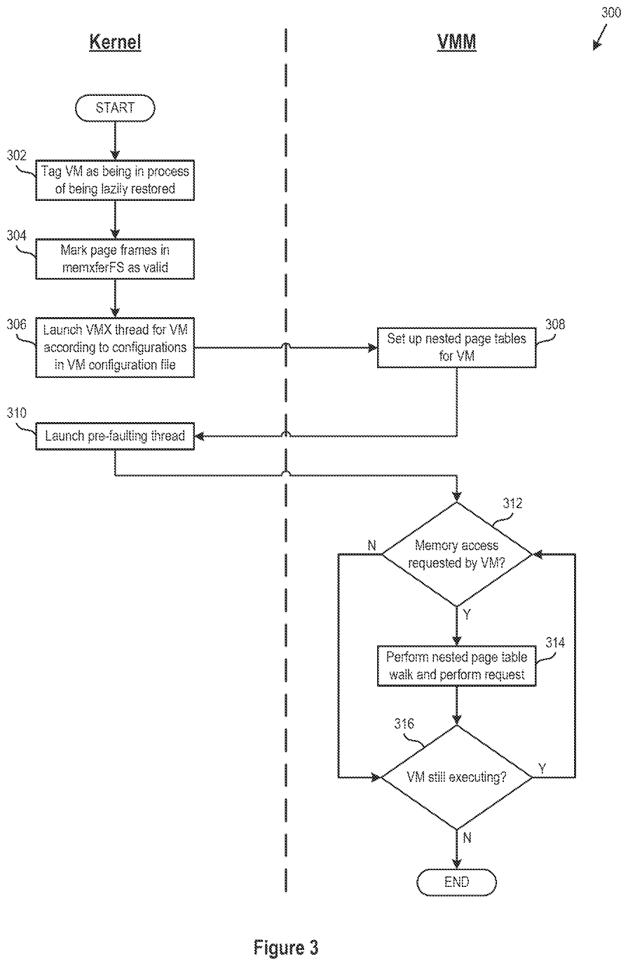

FIG. 3 is a flow diagram of steps carried out by kernel 154 and one of VMMs 152 to carry out a method 300 of restoring page mapping data of corresponding VM 122, according to an embodiment, At step 302, kernel 154 tags VM 122. to indicate that VM 122 is in the process of being lazily restored, e.g., by setting corresponding VM tag 160. At step 304, kernel 154 marks page frames in memxferFS as valid. For example, memory 144 may include invalid bits for each page frame in memxferFS 200. Kernel 154 clears the invalid bits for the page frames to indicate that each of the page frames are valid.

At step 306, kernel 154 launches a VMX thread for VM 122 according to VM configurations in corresponding VM configuration file 148. Hypervisor 150 then creates VMM 152 for VM 122 accordingly. At step 308, newly created VMM 152 sets up nested page tables for VM 122, including the structure thereof. However, such nested page tables are not yet populated with mappings from PPNs to MPNs. At step 310, kernel 154 launches pre-faulting thread 158 for VM 122. Pre-faulting thread 158 then begins the process of lazily restoring page mapping data of VM 122 in the background.

At step 312, VMM 152 determines if there has been a memory access requested by VM 122. For example, VM 122 may have requested to read from or write to a memory page of memory 144, the request including a PPN. If there has not been a memory access requested by VM 122, method 300 moves to step 316. Otherwise, if there has been a memory access requested by VM 122, method 300 moves to step 314.

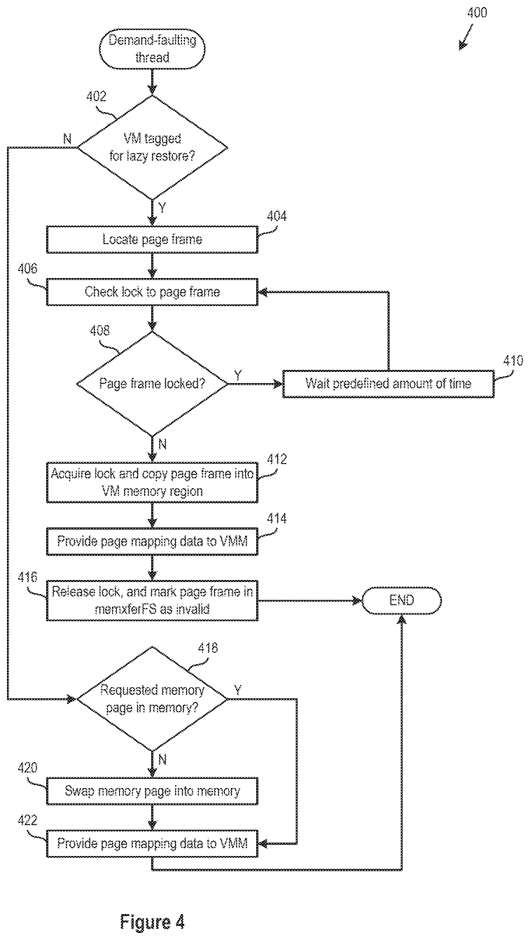

At step 314, VMM 152 performs a nested page table walk for the PPN requested by VM 122 to translate the PPN to an MPN or to determine that a mapping is not present for the requested PPN. If a mapping is present for the requested PPN, VMM 152 performs the request from VM 122 based on the MPN corresponding to the requested PPN. Otherwise, if a mapping is not present, VMM 152 requests for kernel 154 to handle a page fault to enable VMM 152 to perform the request, as discussed further below in conjunction with FIG. 4.

At step 316, if VM 122 is still executing, method 300 returns to step 312, and VMM 152 determines if there has been a new memory access requested by VM 122. Otherwise, if VM 122 is no longer executing, method 300 ends. It should be noted that during steps 312-316, pre-faulting thread 158 lazily restores page mapping data of VM 122 in parallel with demand-faulting thread 156 corresponding to VM 122.

FIG. 4 is a flow diagram of steps carried out by one of demand-faulting threads 156 to carry out a method 400 of handling page faults, which includes restoring page mapping data of corresponding VM 122, according to an embodiment. Method 400 is triggered by a page fault occurring for a PPN requested to be accessed by VM 122. At step 402, demand-faulting thread 156 determines if VM 122 is tagged as being in the process of being lazily restored, by checking corresponding VM tag 160. For example, VM tag 160 being set may indicate that VM 122 is still being lazily restored, while VM tag 160 being cleared may indicate that lazy restoration is complete for VM 122. If VM 122 is tagged as being in the process of being lazily restored, method 400 moves to step 404.

At step 404, demand-faulting thread 156 locates a page frame in memxferFS 200, e.g., by mapping the PPN requested by VM 122 to a page frame number of a page frame in memxferFS 200. At step 406, demand-faulting thread 156 checks a lock to the located page frame. For example, memory 144 may include locks for each page frame moved into memxferFS 200. Such locks synchronize demand-faulting and pre-faulting threads 156 and 158, which may sometimes attempt to access a page frame of memxferFS 200 at the same time. For example, such locks may be bits that are set when corresponding page frames are locked and cleared when corresponding page frames are unlocked.

At step 408, if the located page frame is locked, method 400 moves to step 410, and demand-faulting thread 156 waits a predefined amount of time before checking the lock again. Once the located page frame is unlocked, method 400 moves to step 412. At step 412, demand-faulting thread 156 acquires the lock, e.g., by setting the hit for the lock, and copies the located page frame into the VM memory region, i.e., outside memxferFS 200. At step 414, demand-faulting thread 156 provides page mapping data from the copied page frame to VMM 152, VMM 152 using the page mapping data to populate page tables thereof. At step 416, demand-faulting thread 156 releases the lock, e.g., by clearing the bit for the lock. Demand-faulting thread 156 also marks the page frame in memxferFS 200 as invalid by setting the corresponding invalid bit. After step 416, method 400 ends. It should he noted that after step 408, if the located page frame was e.g., because corresponding pre-faulting thread 158 restored the located page frame, demand-faulting thread 156 does not perform steps 412-416.

Returning to step 402, if VM 122 is not tagged as being in the process of being lazily restored, method 400 moves to step 418. At step 418, demand-faulting thread 156 determines if the requested memory page is in memory 144, e.g., by attempting to map the PPN requested by VM 122 to a page frame number of a page frame in memory 144. If the requested memory page is in memory 144, method 400 moves directly to step 422. Otherwise, if the requested memory page is not in memory 144, method 400 moves to step 420, and demand-faulting thread 156 swaps the requested memory page into a page frame of memory 144 from storage 147. At step 422, demand-faulting thread 156 provides page mapping data for the page frame located at step 418 or swapped into at step 420, to VMM 152. VMM 152 uses the page mapping data to populate page tables thereof. After step 422, method 400 ends.

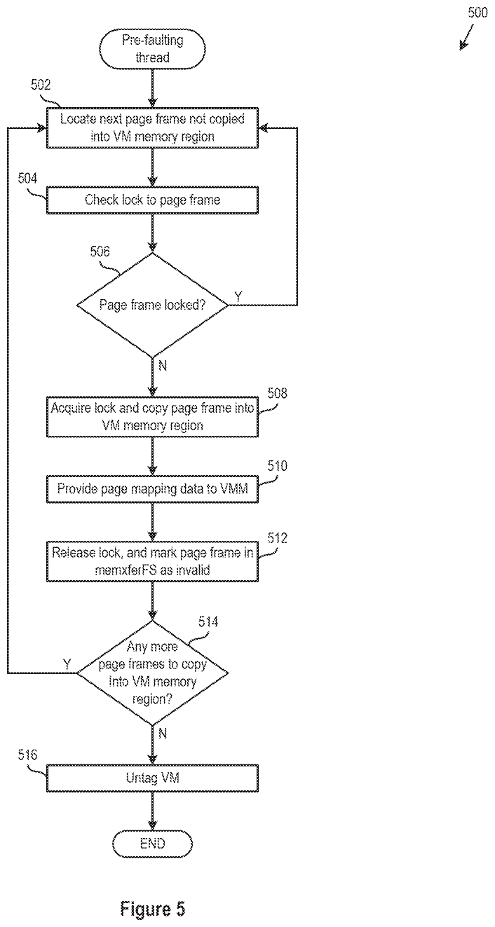

FIG. 5 is a flow diagram of steps carried out by one of pre-faulting threads 158 to carry out a method 500 of restoring page mapping data of corresponding VM 122 in the background, according to an embodiment. Method 500 is triggered by kernel 154 launching pre-faulting thread 158. At step 502, pre-faulting thread 158 locates the next page frame of memxferFS 200 (e.g., in sequence according to its address in memxferFS 200) that has not yet been copied into the VM memory region, i.e., copied outside memxferFS 200.

At step 504, pre-faulting thread 158 checks a lock to the located page frame. At step 506, if the located page frame is locked, method 500 returns to step 502, and pre-faulting thread 158 locates the next page frame of memxferFS 200 that has not yet been copied into the VM memory region, the page frame after the locked page frame. Otherwise, if the located page frame is unlocked, method 500 moves to step 508. At step 508, pre-faulting thread 158 acquires the lock, e.g., by setting the bit for the lock, and copies the located page frame into the VM memory region, i.e., outside memxferFS 200. At step 510, pre-faulting thread 158 provides page mapping data from the copied page frame to VMM 152, VMM 152 using the page mapping data to populate page tables thereof.

At step 512, pre-faulting thread 158 releases the lock, e.g., by clearing the bit for the lock. Pre-faulting thread 158 also marks the page frame in memxferFS 200 as invalid by setting the corresponding invalid bit. It should be noted that after step 506, if the located page frame was invalid, e.g., because corresponding demand-faulting thread 156 restored the located page frame, pre-faulting thread 158 does not perform steps 508-512. At step 514, pre-faulting thread 158 determines if there are any more page frames to copy into the VM memory region. If there is at least one more page frame to copy into the VM memory region, method 500 returns to step 502, and pre-faulting thread 158 locates the next such page frame. Otherwise, if there are no such page frames, method 500 moves to step 516, and pre-faulting thread 158 untags VM 122, e.g., by clearing corresponding VM tag 160. After step 516, method 500 ends, and lazy restoration is complete for VM 122.

While a VM 122 is being lazily restored, because VM 122 is already running, another VM operation may be started even though some page frames of VM 122 have not yet been copied into the VM memory region, and corresponding VMM 152 has not yet re-populated page tables therewith. Such VM operations include, for example, a power off or rebooting, “fast suspend and resume” (FSR), “live” VM migration, memory snapshot, suspend-to-storage operation, memory page remapping, memory page sharing, or swapping of a memory page to storage 147. Based on nature of the VM operation, hypervisor 150 determines how to execute the VM operation without unnecessary delay.

For example, in the case of a power off or rebooting of VM 122, kernel 154 stops corresponding pre-faulting thread 158. Hypervisor 150 then deletes memory pages for VM 122 from memory 144, including page frames of VM 122 still residing in memxferFS 200 to free up the memory space for other processes. Furthermore, for any memory pages containing changes that have not been persisted in storage 147, referred to as “dirty” memory pages, hypervisor 150 persists the changes in storage 147.

In the case of FSR, kernel 154 suspends VM 122 by terminating the VMX thread for VM 122 and resumes VM 122 by instantiating a new VMX thread. However, corresponding VMM 152 retains page tables for VM 122, so the FSR operation is unaffected by VM 122 still being in the process of being lazily restored. Accordingly, kernel 154 may perform the FSR in parallel with the lazy restoration.

A live migration of VM 122 involves transferring VM 122, including memory pages thereof, to another “destination” host while VM 122 is executing. A memory snapshot of VM 122 includes marking memory pages of VM 122, in particular its page table entries, as read-only. A suspend-to-storage operation involves copying memory pages of VM 122. from memory 144 to storage 147. Each such operation requires the page mapping data for VM 122 to he completely restored, so kernel 154 stops pre-faulting thread 158, and immediately restores the page mapping data of VM 122 using the locks for page frames in memxferFS 200 for synchronization, and then hypervisor 150 performs the VM operation.

Memory page remapping may involve, remapping some memory pages of one size such as 4 KB to memory pages of another size such as 2 MB. Memory page remapping may also involve, e.g., moving some memory pages closer to CPU(s) 142, such remapping also referred to as non-uniform memory access (NUMA) remapping. Page sharing involves mapping multiple PPNs to the same MPN such as to an MPN corresponding to a page of zeroes. For each of memory page remapping, page sharing, and swapping memory pages to storage, kernel 154 restores the page mapping data of VM 122 for the memory pages involved in the VM operation, using the locks for the corresponding page frames in memxferFS 200 for synchronization. Hypervisor 150 then performs the VM operation.

The embodiments described herein may employ various computer-implemented operations involving data stored in computer systems. For example, these operations may require physical manipulation of physical quantities. Usually, though not necessarily, these quantities are electrical or magnetic signals that can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations. The embodiments described herein may also be practiced with computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data that can thereafter be input into a computer system. Computer readable media may be based on any existing or subsequently developed technology that embodies computer programs in a manner that enables a computer to read the programs. Examples of computer readable media are HDDs, SSDs, network-attached storage (NAS) systems, read-only memory (ROM), RAM, compact disks (CDs), digital versatile disks (DVDs), magnetic tapes, and other optical and non-optical data storage devices. A computer readable medium can also be distributed over a network-coupled computer system so that computer-readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and steps do not imply any particular order of operation unless explicitly stated in the claims.

Virtualized systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data. Many variations, additions, and improvements are possible, regardless of the degree of virtualization. The virtualization software can therefore include components of a host, console, or guest OS that perform virtualization functions.

Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined component. Similarly, structures and functionalities presented as a single component may be implemented as separate components. These and other variations, additions, and improvements may fall within the scope of the appended claims.

What is claimed is:

1. A method of restarting execution of a virtual machine (VM) on a host, after an upgrade of a virtualization software for the VM, wherein prior to the upgrade, the execution of the VM on the host was suspended and page mapping data for mapping memory pages of the VM to first page frames located in a first region of a physical memory of the host was copied into second page frames located in a second region of the physical memory of the host, said method comprising:
restarting execution of the VM on the host after the upgrade while the page mapping data for mapping the memory pages of the VM to the first page frames located in the first region of the physical memory, are stored in the second page frames located in the second region of the physical memory; and
during said execution of the VM after the upgrade, copying a portion of the page mapping data stored in the second page frames into a third page frame located in the first region of the physical memory.

2. The method of claim 1, further comprising:
after said copying into the third page frame, populating page tables of the VM with the copied portion of the page mapping data.

3. The method of claim 2, wherein said copying into the third page frame is carried out by a background thread that is configured to copy, one page frame at a time, the page mapping data stored in the second page frames into page frames located in the first region of the physical memory.

4. The method of claim 2, wherein said copying into the third page frame is carried out in response to a page fault triggered as a result of one of the memory pages of the VM being requested to be accessed.

5. The method of claim 1, further comprising:
during said execution of the VM after the upgrade, copying another portion of the page mapping data stored in the second page frames into a fourth page frame located in the first region of the physical memory, wherein
said copying into the third page frame is carried out by a background thread that is configured to copy, one page frame at a time, the page mapping data stored in the second page frames into page frames located in the first region of the physical memory, and
said copying into the fourth page frame is carried out in response to a page fault triggered as a result of one of the memory pages of the VM being requested to be accessed while the background thread is running.

6. The method of claim 1, wherein the second region of the physical memory of the host is a fixed virtual address space created during booting of the host.

7. The method of claim 1, further comprising:
during said execution of the VM after the upgrade and prior to said copying into the third page frame, determining if the portion of the page mapping data is locked, acquiring a lock for the portion of the page mapping data if unlocked, and waiting for a release of the lock for the portion of the page mapping data if locked.

8. A non-transitory computer-readable medium comprising instructions to be executed in a computer system to cause a processor of the computer system to carry out a method of restarting execution of a virtual machine (VM) in the computer system, after an upgrade of a virtualization software for the VM, wherein prior to the upgrade, the execution of the VM in the computer system was suspended and page mapping data for mapping memory pages of the VM to first page frames located in a first region of a physical memory of the computer system was copied into second page frames located in a second region of the physical memory of the computer system, said method comprising:
restarting execution of the VM in the computer system after the upgrade while the page mapping data for mapping the memory pages of the VM to the first page frames located in the first region of the physical memory, are stored in the second page frames located in the second region of the physical memory; and
during said execution of the VM after the upgrade, copying a portion of the page mapping data stored in the second page frames into a third page frame located in the first region of the physical memory.

9. The non-transitory computer-readable medium of claim 8, wherein said method further comprises:
after said copying into the third page frame, populating page tables of the VM with the copied portion of the page mapping data.

10. The non-transitory computer-readable medium of claim 9, wherein said copying into the third page frame is carried out by a background thread that is configured to copy, one page frame at a time, the page mapping data stored in the second page frames into page frames located in the first region of the physical memory.

11. The non-transitory computer-readable medium of claim 9, wherein said copying into the third page frame is carried out in response to a page fault triggered as a result of one of the memory pages of the VM being requested to be accessed.

12. The non-transitory computer-readable medium of claim 8, wherein said method further comprises:
during said execution of the VM after the upgrade, copying another portion of the page mapping data stored in the second page frames into a fourth page frame located in the first region of the physical memory, wherein
said copying into the third page frame is carried out by a background thread that is configured to copy, one page frame at a time, the page mapping data stored in the second page frames into page frames located in the first region of the physical memory, and
said copying into the fourth page frame is carried out in response to a page fault triggered as a result of one of the memory pages of the VM being requested to be accessed while the background thread is running.

13. The non-transitory computer-readable medium of claim 8, wherein the second region of the physical memory of the computer system is a fixed virtual address space created during booting of the computer system.

14. The non-transitory computer-readable medium of claim 8, wherein said method further comprises:
During said execution of the VM after the upgrade and prior to said copying into the third page frame, determining if the portion of the page mapping data is locked, acquiring a lock for the portion of the page mapping data if unlocked, and waiting for a release of the lock for the portion of the page mapping data if locked.

15. A computer system comprising a processor and physical memory, wherein the processor is programmed to carry out a method of restarting execution of a virtual machine (VM) in the computer system, after an upgrade of a virtualization software for the VM, wherein prior to the upgrade, the execution of the VM in the computer system was suspended and page mapping data for mapping memory pages of the VM to first page frames located in a first region of the physical memory of the computer system was copied into second page frames located in a second region of the physical memory of the computer system, said method comprising:
restarting execution of the VM in the computer system after the upgrade while the page mapping data for mapping the memory pages of the VM to the first page frames located in the first region of the physical memory, are stored in the second page frames located in the second region of the physical memory; and
during said execution of the VM after the upgrade, copying a portion of the page mapping data stored in the second page frames into a third page frame located in the first region of the physical memory.

16. The computer system of claim 15, wherein said method further comprises:
after said copying into the third page frame, populating page tables of the VM with the copied portion of the page mapping data.

17. The computer system of claim 16, wherein said copying into the third page frame is carried out by a background thread that is configured to copy, one page frame at a time, the page mapping data stored in the second page frames into page frames located in the first region of the physical memory.

18. The computer system of claim 16, wherein said copying into the third page frame is carried out in response to a page fault triggered as a result of one of the memory pages of the VM being requested to be accessed.

19. The computer system of claim 15, wherein said method further comprises:
during said execution of the VM after the upgrade, copying another portion of the page mapping data stored in the second page frames into a fourth page frame located in the first region of the physical memory, wherein
said copying into the third page frame is carried out by a background thread that is configured to copy, one page frame at a time, the page mapping data stored in the second page frames into page frames located in the first region of the physical memory, and
said copying into the fourth page frame is carried out in response to a page fault triggered as a result of one of the memory pages of the VM being requested to be accessed while the background thread is running.

20. The computer system of claim 15, wherein the second region of the physical memory of the host is a fixed virtual address space created during booting of the host.

21. The computer system of claim 15, wherein said method further comprises:
During said execution of the VM after the upgrade and prior to said copying into the third page frame, determining if the portion of the page mapping data is locked, acquiring a lock for the portion of the page mapping data if unlocked, and waiting for a release of the lock for the portion of the page mapping data if locked.
